(19) United States
(12) Patent Application Publication
(10) Pub. No.: US 2009/0197992 A1
(43) Pub. Date: Aug. 6, 2009

(54) COATING COMPOSITION

(75) Inventor: Ronald Scott Charnock, Bedfordshire (GB)

Correspondence Address: ROETZEL AND ANDRESS, 222 SOUTH MAIN STREET, AKRON, OH, 44308, US

(73) Assignee: IMPERIAL CHEMICAL INDUSTRIES, PLC, London (GB)

(21) Appl. No.: 11/915,250

(22) PCT Filed: Apr. 21, 2006
(86) PCT No.: PCT/EP2006/003699

§ 371 Date: Jun. 17, 2008

(30) Foreign Application Priority Data
May 25, 2005 (GB) GB0510650.5

(51) Int. Cl. C09D 113/02

(52) U.S. Cl. 524/5; 524/418

(57) ABSTRACT

A coating composition comprising a first part, and a second part, in which the first part includes gypsum and/or cement dispersed in a water miscible organic solvent, and the second part includes a water soluble polymer, the first and second parts being mixable so as to form a hardened coating composition.

### BACKGROUND OF THE INVENTION

The present invention relates to a coating composition.

Known coating compositions, for example fillers, are applied to substrates, such as a wall, to cover imperfections in the wall.

GB2382582 describes a two part coating composition including a first part containing, amongst other components, a mixture of calcium sulphate hemihydrate (gypsum) in water, and an alkaline polymer, and a second part containing, amongst other components, an acidic polymer. The first and second parts are mixed together, whereupon the calcium sulphate hemihydrate reacts with the water to form the calcium sulphate dihydrate which is a hardened composition.

One disadvantage of this composition is the requirement of a hydration inhibitor in the first part to prevent the premature setting of the gypsum by reacting with water in the alkaline polymer to form calcium sulphate dihydrate.

Another disadvantage of this composition is that to ensure the pH of the first part is alkaline, so as to maintain stability, it is necessary to use an alkaline polymer in the first part.

A further disadvantage of this composition is that an acidic polymer is required in the second part to ensure that once mixed with the alkaline polymer of the first part, the mixture obtains a neutral pH, this being important for the safety of the consumer when using the composition.

### SUMMARY OF THE INVENTION

An object of the present invention is to provide a coating composition which overcomes or at least mitigates some of these disadvantages.

Thus according to the present invention, there is provided a coating composition comprising a first part, and a second part, in which the first part includes gypsum and/or cement dispersed in a water miscible organic solvent, and the second part includes a water soluble polymer, the first and second parts being mixable so as to form a hardened coating composition.

Advantageously, the first part of composition of the present invention does not contain water for the gypsum to react with, and since the gypsum does not chemically react with the water miscible organic solvent, there is no requirement for a hydration inhibitor to prevent the premature setting of the gypsum. Accordingly the present invention is simpler than that described in GB2382582 since firstly no hydration inhibitor is required in the first part, and consequently no activator is required in the second part.

Advantageously, the water miscible organic solvent also acts as a retarder to slow the hydraulic setting of the gypsum once the first and second parts are mixed.

furthermore, there is no requirement for an alkaline polymer in the first part to ensure the pH is alkaline and therefore prevent the gypsum from setting before mixing. Consequently, there is no requirement for an acidic polymer in the second part to ensure that once mixed with the alkaline first part, the mixture obtains a neutral pH for safe consumer use.

Thus the composition of the present invention is not pH dependant for stability or set properties.

Another advantage of the present invention is that an organic solvent can be selected with a lower boiling point than water, which means the mixture of the first and second parts can dry quicker after set has occurred since formulations can be made where there may not be an excess of water to lose by evaporation.

A further advantage of carrying the gypsum in an organic solvent rather than water is that the organic solvent speeds up the set time of the mixture because it acts as an azeotrope to remove excess water in the system that is not required to react with the gypsum hemihydrate to form the dihydrate.

### DETAILED DESCRIPTION OF THE INVENTION

The present invention will now be described, by way of example only.

A coating composition comprises a first part A1, and a second part B1.

Part A1 comprises gypsum in the form of beta-calcium sulphate hemihydrate, a water miscible organic solvent in the form of an aliphatic alcohol such as isopropanol, a thickener in the form of hydroxy propyl methyl cellulose, and a dispersant in the form of a sodium salt of a an acrylic polymer.

Table 1 below indicates the trade name and parts by weight of the components of part A1, together with the source.

TABLE 1

| | | Parts by |
|---|---|---|
| Trade Name | Component | Weight |
| Keramod A20 | beta-calcium sulphate | 100 |
| Heidelberger Cement, Germany | hemihydrate | |
| | isopropanol | 43 |
| Methocell 311 | hydroxy propyl methyl | 2.4 |
| Dow Chemical Company, UK | cellulose | |
| Dispex N40 | sodium salt of an acrylic | 0.48 |
| Allied Colloids, UK | polymer | |

The isopropanol acts as a carrier dispersion solvent for the gypsum, and therefore the level of isopropanol is selected to be as low as possible so as to achieve a stable workable paste since, as soon as the first and second parts are mixed, the isopropanol is required to be lost by evaporation as quickly as possible.

Alternatively, alpha calcium sulphate hemihydrate could be used instead of the beta form. An alternative to gypsum is cement, and furthermore, it is possible to use mixtures of both gypsum and cement. It is possible to use any hydraulic setting material instead of gypsum or cement providing the resultant set composition is suitable for the end use requirements.

In an alternative embodiment it is possible to use polyhydric aliphatic alcohols such as ethylene glycol or glycerol either alone or in blends with mono-alcohols and also aromatic alcohols that are water soluble.

Alternative thickeners include polyacrylate, china clay, or any other thickeners which would give a workable paste.

In addition to the components given above, part A1 could also include surfactants and/or dispersants to give a stable homogenous paste.

It is also possible to include other components in part A1, such as calcium sulphate dihydrate, which acts to reduce the setting time when parts A1 and B1 are mixed, extenders such as calcites, silicas, cements and dolomites which act to provide the required mechanical properties of the set composite such as structural strength and dimensional stability, titanium dioxide which acts to give a whiter product, and pigments to add colour to the composition.

An alternative composition for part A1, indicated as part A2 (using an alternative gypsum supplier), is given in Table 2.

TABLE 2

| | | Parts by |
|---|---|---|
| Trade Name | Component | Weight |
| Prestia 23 | beta-calcium sulphate | 100 |
| Lafarge, France | hemihydrate | |
| | isopropanol | 37 |
| Methocell 311 | hydroxy propyl methyl | 2 |
| | cellulose | |
| Dispex N40 | sodium salt of an acrylic | 0.4 |
| | polymer | |

Part B comprises a water soluble polymer in the form of a polymer latex. The polymer latex is vinyl acetate-VeoVA 10-butyl acrylate terpolymer which acts to provide flexibility and binding properties and an extender in the form of calcium carbonate which acts to provide mechanical properties, a defoaming agent in the form of mineral oil to reduce tendency to foam during incorporating into the mix surface active materials, and a dispersant in the form of a sodium salt of a acrylic polymer to give a uniform dispersion of the particulate materials used.

Alternative polymers that could be used include those based on acrylates, vinyl versatate (mixed vinyl esters of branched chain fatty acids commonly know as versatic acid), methacrylates, vinyl chloride, ethylene, and styrene.

Other alternative polymers include celluloses, starches, and natural gums such as alginates, and guar. Synthetic polymers such as polyvinyl alcohol, polyvinyl pyrrolidones, polyvinyl methyl ethers, polyacrylic acid and its salts, polacrylamides and ethylene oxide polymers can also be used.

The polymer is selected so as to modify as required the properties of the set formulation of the first and second parts. Such properties include water resistance, exterior durability, adhesion, flexibility, toughness, strength, and resistance to powdering of the set gypsum. The extent of the requirement of these properties will be determined by the end use application, for example, flexibility in wood repair to resist natural movement in wood uses in construction.

Table 3 below indicates the trade name and parts by weight of the components of part B1.

TABLE 3

| | | Parts by |
|---|---|---|
| Trade Name | Component | Weight |
| Synthomer VV531, | poly (Va-VeoVa 10-Ba) in latex | 37 |
| Synthomer Ltd, UK | form | |
| Ulmerweiss WL, | calcium carbonate | 83 |
| Brenntag Specialities | | |
| Holland | | |
| Agitan 281, Munzig | mineral oil | 0.25 |
| Chemie, Germany | | |
| Dispex N40 | Sodium salt of an acrylic | 0.25 |
| | polymer | |

Part B can also include a thickener such as a cellulose ether, polyacrylate, china clay, or any other thickeners which would give a workable paste.

In addition to the components given above, part B could also include surfactants and/or dispersants to give a stable homogenous paste in the same way as part A.

Part B can also include extenders such as calcites, silicas, cements and dolomites.

It is also possible to increase the hydraulic setting time of the gypsum by the addition of a retarder such as mono or poly carboxylic acid (such as citric, fumaric, or itaconic), cellulose ethers such as hydroxyethyl cellulose or carboxymethylcellulose.

Conversely, accelerators such as metallic salts, for example, calcium sulphate, aluminium sulphate or ferric chloride can be added to decrease the hydraulic setting time.

Clearly, the setting time would be adjusted according to the working requirements of the mixed parts.

In addition to the components identified above, it is also possible to add antifoams, lightweight additives such as glass or ceramic spheres, colourants, and odourants to either part A or B.

An alternative composition for part B2, indicated as part B2 is given in Table 4.

TABLE 4

| | | Parts by |
|---|---|---|
| Trade Name | Component | Weight |
| Syntomer VV531 | Poly (Va-VeoVa 10-Ba) in latex | 37 |
| | form | |
| Ulmerweiss WL | calcium carbonate | 83 |
| Agitan 281 | mineral oil | 0.25 |
| Dispex N40 | sodium salt of an acrylic | 0.25 |
| | polymer | |
| Superfine white | calcium sulphate dehydrate | 2 |

It can be seen from Table 4 that B2 differs from B1 by the addition of calcium sulphate dihydrate.

After preparing parts A and B as described above, the two parts are mixed in the ratio 2:1 by weight. In alternative embodiments the two parts can be mixed in a ratio between and including four parts first part to one part second part and one part first part to four parts second part.

After mixing parts A and B, the calcium sulphate hemihydrate of the first part reacts with the water in the polymer latex to form the calcium sulphate dihydrate which is a hardened composition. The polymer is deposited from the latex and coalesces to form a binder for the particulate material in the mix.

Table 5 shows the results of mixing parts A and B as described in the embodiments above.

TABLE 5

| Mix | A1/B1 | A1/B2 | A2/B1 |
|---|---|---|---|
| Mix ratio (wt) | 2:1 | | |
| Consistency | Smooth workable paste | | |
| Work life (minutes) | 10 | 8 | 15 |
| Time to full set (hours) | 10 | 10 | 10 |

| | |
|---|---|
| Appearance once set | Hard set composition |

It can be seen from Table 5 that the compositions of parts A and B produce a workable paste which produced a hardened composition once mixed and set.

The addition of calcium sulphate dihydrate between B1 and B2 results in a reduced work life since it accelerates the setting time as it provides nuclei of crystallisation of the dihydrate.

The coating composition can be used on numerous applications where it is necessary to apply a workable composition to a surface, whereupon the composition then sets to form a hardened composition, for example, fillers, surface skimmers such as wall equalisers and plasters, wood repairs, and flooring compositions.

1. A coating composition comprising a first part, and a second part, in which the first part includes gypsum and/or cement dispersed in a water miscible organic solvent, and the second part includes a water soluble polymer, the first and second parts being mixable so as to form a hardened coating composition.

2. A coating composition according to claim 1 in which the first part is mixed with the second part in a weight ratio between and including four parts first part to one part second part and one part first part to four parts second part.

3. A coating composition according to claim 2 in which the first part is mixed with the second part in a weight ratio between one part first part to one part second part, and two parts first part to one part second part.

4. A coating composition according to claim 3 in which the first part is mixed with the second part in a weight ratio two parts first part and one part second part.

5. A coating composition according to any preceding claim in which the water miscible organic solvent is an aliphatic alcohol.

6. A coating composition according to claim 5 in which the aliphatic alcohol is isopropanol.

7. A coating composition according to any preceding claim in which the first and/or second parts further include a surfactant and/or a dispersant.

8. A coating composition according to any preceding claim in which the polymer latex is a derivative of vinyl acetate.

9. A coating composition according to any preceding claim in which the coating composition is a filler.

10. A coating composition according to any preceding claim in which the water soluble polymer is a latex.
